(19) United States
(12) Patent Application Publication
(10) Pub. No.: US 2010/0082637 A1
(43) Pub. Date: Apr. 1, 2010

(54) Web Page and Web Site Importance Estimation Using Aggregate Browsing History

(75) Inventors: Gilad Mishne, Santa Clara, CA (US); Guangyu Zhu, Sunnyvale, CA (US)

Correspondence Address: BAKER BOTTS L.L.P., 2001 ROSS AVENUE, 6TH FLOOR, DALLAS, TX, 75201, US

(73) Assignee: Yahoo; Inc., Sunnyvale, CA (US)

(21) Appl. No.: 12/241,299

(22) Filed: Sep. 30, 2008

(51) Int. Cl. G06F 17/30

(52) U.S. Cl. 707/748; 707/E17.044

(57) ABSTRACT

Particular embodiments of the present invention are related to estimating the importance of web sites based on the aggregate browsing history of one or more users.

### TECHNICAL FIELD

The present disclosure generally relates to estimating the importance of web pages and/or web sites, and more specifically to assigning importance to web content at the site or host level.

### BACKGROUND

A web search engine is designed to search for information on the World Wide Web (the Internet). Some search engines identify web pages, images, and/or other types of files in response to search terms queried by a user. A search engine may operate based on an algorithm, in contrast with a web directory which is typically a listing of information maintained by a human editor. In the early 1990s, there was an attempt to list all active webservers in a directory hosted on the CERN webserver.

Early web search engines provided a list of web sites or links to users based on a text search in the title of a webpage or the URL. Soon, the standard for major search engines included a text search of all content in any webpage. Some search providers offered a hybrid system, e.g., performing a text search only on webpages within a web directory managed by a human. As another example, some search providers preferentially returned a search result of sponsored links or websites. These systems were subject to manipulation by web hosts and servers who included text on their page calculated to generate search hits as opposed to actual content.

The next step in the development of search engine methodology employed a page ranking system. In such systems, text searches may be supplemented by one or more algorithms for identifying pages of special importance or value. For example, one well-known page ranking technique includes ranking pages based on the number and rank of web pages providing a link to the page. The premise of such systems is that useful or interesting pages are linked to more often than other pages.

FIG. 1 shows a computer screen display 1 displaying the search results for a web engine employing a prior art method for estimating site importance. Display 1 includes an application bar 10, a tool bar 30, a search tool 32, and search results 34.

Application bar 10 includes application buttons 12, 14, and 16, and time and date block 18. Tool bar 30 may include any of several tool bars available for use with a web browser (e.g., Yahoo!, Google, and Microsoft). Search tool 32 includes an input block allowing a user to enter search terms. Search results 34 includes the output of a search engine using a prior art technique for estimating the importance of web sites (e.g., using a page ranking system based on link structures).

Page ranking techniques based on link structure have several drawbacks. Estimating page ranks based on the underlying links between pages requires a large computing capacity to properly map the Internet. Additionally, such page rank schemes are still subject to manipulation by web hosts or servers. In some instances, web hosts may “trade” links between pages for the sole purpose of increasing their respective page ranks.

### SUMMARY

The present invention provides methods, apparatuses and systems directed to estimating web site or web page importance. Particular implementations of the invention are directed to calculating an aggregate importance value based on a relative importance value of a web page in a filtered set of web page browsing sessions.

### DESCRIPTION OF THE DRAWINGS

FIG. 1 illustrates a computer screen displaying the result from a prior art search engine.

FIG. 2 is a schematic diagram that illustrates an example network environment in which particular implementations of the invention may operate.

FIG. 3 is a flow chart showing an example method associated with particular implementations of the invention.

FIG. 4 is a diagram showing an example method associated with particular implementations of the invention.

FIG. 5 illustrates a computer screen displaying the result from a search engine implementing methods of the current invention.

FIG. 6 is a schematic diagram illustrating an example computing system architecture that may be used to implement one or more of physical servers.

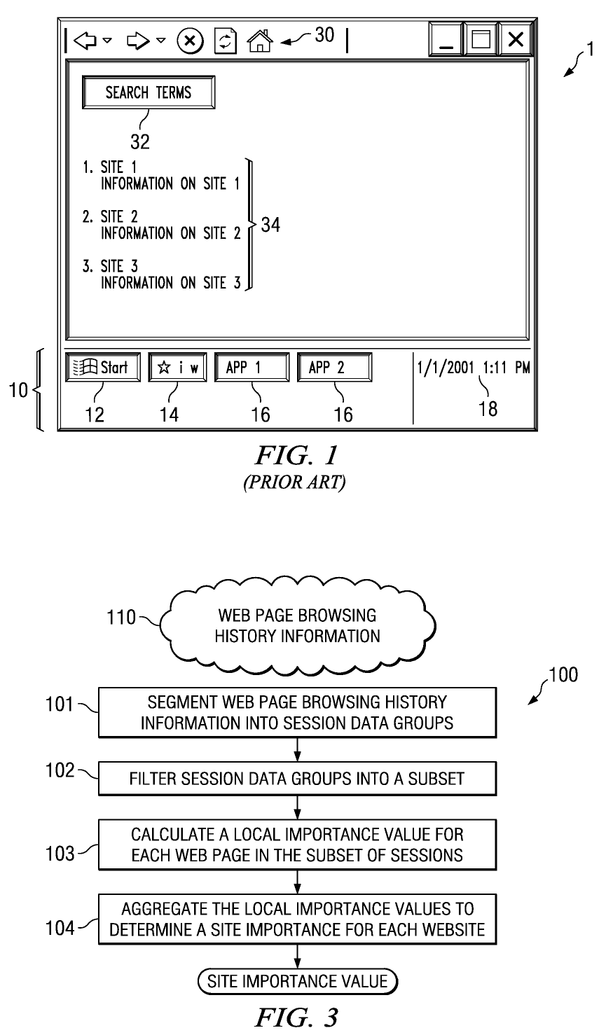

### DESCRIPTION OF EXAMPLE EMBODIMENT(S)

### A. Example Network Environment

Particular implementations of the invention operate in a wide area network environment, such as the Internet, including multiple network addressable systems. Network cloud 60 generally represents one or more interconnected networks, over which the systems and hosts described herein can communicate. Network cloud 60 may include packet-based wide area networks (such as the Internet), private networks, wireless networks, satellite networks, cellular networks, paging networks, and the like.

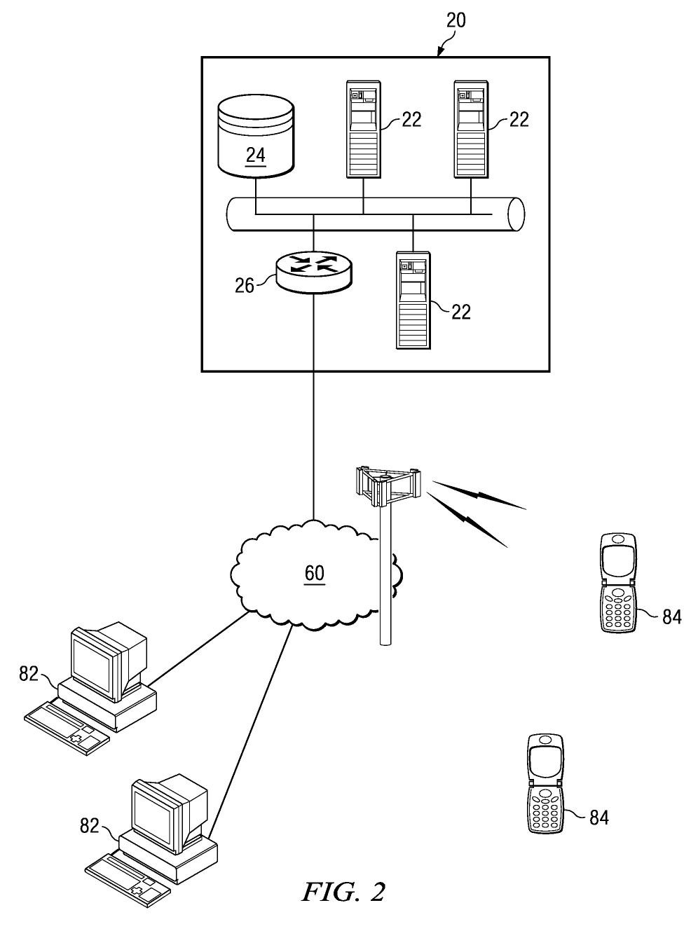

As FIG. 2 illustrates, a particular implementation of the invention can operate in a network environment 10 comprising network application hosting site 20, such as an informational web site, social network site and the like. Although FIG. 2 illustrates only one network application hosting site, implementations of the invention may operate in network environments that include multiples of one or more of the individual systems and sites disclosed herein. Client nodes 82 are operably connected to the network environment via a network service provider or any other suitable means.

Network application hosting site 20 is a network addressable system that hosts a network application accessible to one or more users over a computer network. The network application may be an informational web site where users request and receive identified web pages and other content over the computer network. The network application may also be a search platform, an on-line forum or blogging application where users may submit or otherwise configure content for display to other users. The network application may also be a social network application allowing users to configure and maintain personal web pages. The network application may also be a content distribution application, such as Yahoo! Music Engine®, Apple® iTunes®, podcasting servers, that displays available content, and transmits content to users.

Network application hosting site 20, in one implementation, comprises one or more physical servers 22 and content data store 24. The one or more physical servers 22 are operably connected to computer network 60 via a router 26. The one or more physical servers 22 host functionality that provides a network application (e.g, a news content site, etc.) to a user. In one implementation, the functionality hosted by the one or more physical servers 22 may include web or HTTP servers and the like. Still further, some or all of the functionality described herein may be accessible using an HTTP interface or presented as a web service using SOAP or other suitable protocols. In some implementations, one or more physical servers 22 may provide any of the functionality discussed below, e.g., for collecting and processing user web site browsing history, e.g., to determine web site/web page “importance values” for use by a search engine.

Content data store 24 stores content as digital content data objects. A content data object or content object, in particular implementations, is an individual item of digital information typically stored or embodied in a data file or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, etc. Structurally, content data store 24 connotes a large class of data storage and management systems. In particular implementations, content data store 24 may be implemented by any suitable physical system including components, such as database servers, mass storage media, media library systems, and the like.

Network application hosting site 20, in one implementation, provides web pages, such as front pages, that include an information package or module describing one or more attributes of a network addressable resource, such as a web page containing an article or product description, a downloadable or streaming media file, and the like. The web page may also include one or more ads, such as banner ads, text-based ads, sponsored videos, games, and the like. Generally, web pages and other resources include hypertext links or other controls that a user can activate to retrieve additional web pages or resources. A user “clicks” on the hyperlink with a computer input device to initiate a retrieval request to retrieve the information associated with the hyperlink or control. In some implementations of network application hosting site 20, network application hosting site 20 may be operative to collect web site browsing history, and/or process web site browsing history (e.g., to determine web site/web page “importance values” for use by a search engine) in accordance with teachings of the present invention.

### B. Overview of the Present Invention

Particular embodiments of the present invention are related to estimating site importance of web sites or web pages. Web sites may include one or more individual web pages. Some embodiments may be used in conjunction with web search engines. In contrast to prior art methods for estimating site importance, the methods of the present disclosure may be based on behavior patterns of web page viewers, rather than the underlying architecture of the web page or the Internet itself.

A web page is a single document identified by a URL. A web site may be a collection of web pages, images, and other digital resources. In general, the importance ranking for a web site may be calculated based on the importance ranking calculated for the web pages associated with the web site (e.g., the sum of importance values of the individual web pages, the average of importance values of the individual web pages, the maximum importance value of any web page, etc.).

Web site browsing history information may include a set of data regarding the browsing history of one or more users. Browsing history, for example, may include the history of web pages accessed by a user, the time at which they were accessed, and/or the method by which they were accessed. Web site browsing history information may also include demographic information describing the user. Web site browsing information may be gathered by several methods, either at the user side (e.g., through the web browser toolbars offered by Yahoo!, Google, and Microsoft) and/or at an Internet Service Provider server (e.g., by a special proxy).

### C. Implementation

FIG. 3 is a flow chart showing an example method 100 associated with particular implementations of the invention. Method 100 may use web page browsing history information to generate site importance values for one or more web sites, which site importance values may be used in for ranking web sites (e.g., by a search engine). Method 100 may include steps to be performed by a series of computer-executable instructions carried on a computer readable medium. For example, method 100 may be implemented by any suitable components) of network application hosting site 20.

At Step 101, web page browsing history information may be segmented into one or more session data groups. Each session data group may correspond to one browsing session by a particular user and may include browsing history data regarding one or more web pages visited during that browsing session by the particular user. A browsing session may correspond to a contiguous segment of action by the user.

Web page browsing history information may be segmented into session data groups (e.g., sessions) using one or more techniques. One example segmenting technique may include assuming a new session if there was no activity recorded for a predetermined amount of time (e.g., a session timeout after 10 minutes). Another example segmenting technique may include following http referrer information to identify when a user browsed from site to site. Another example segmenting technique may include following http referrer information to identify when a user hit a bookmark. Another example segmenting technique may include reviewing other user actions (e.g., opening or closing browser windows or tabs, following a stored page bookmark, refreshing the contents of a web page, and/or any other user actions related to browsing activities).

At Step 102, session data groups may be filtered into subsets of session data groups. Filtering may be based on any of several filtering criteria. Certain subsets of session data groups may allow analysis of web page browsing history using various conditions to achieve different importance semantics. For example, certain filtering criteria may be designed to provide a subset of session data groups that includes only sessions from a particular demographic of users (e.g., sorted by age group, geographical location, sex, race, etc.). As another example, certain filtering criteria may be designed to provide a subset of session data groups that includes only sessions from a certain date or time of day (e.g., all sessions from January 2008, sessions occurring before noon, sessions occurring during the local lunch hour of the user). As another example, certain filtering criteria may be designed to provide a subset of session data groups that includes only sessions containing a particular activity (e.g., a search request, a click on a banner ad, a visit to a web-based email program, etc.).

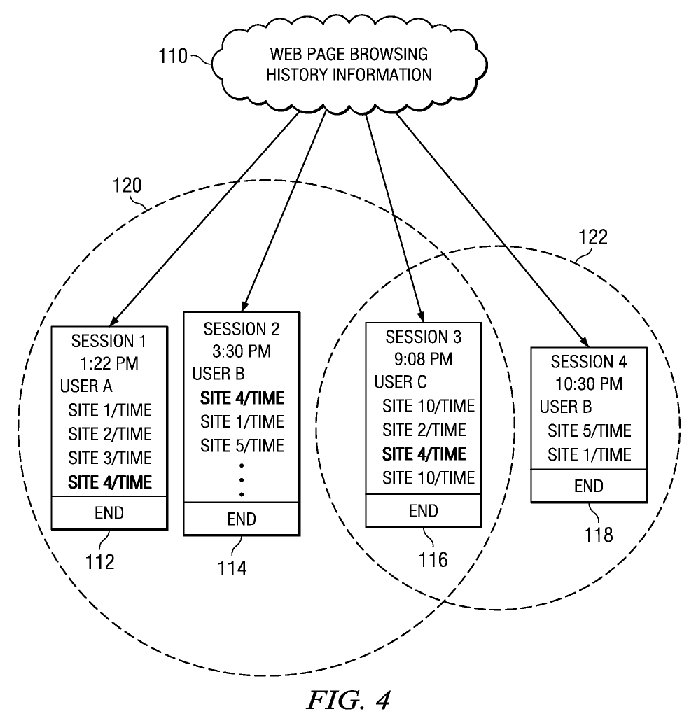

FIG. 4 is a diagram showing a schematic for one embodiment of the present invention demonstrating example techniques for segmenting and filtering web page browsing information 110 at Step 102 of method 100. Data from web page browsing information 110 may be segmented into multiple session data groups (112, 114, 116, and 118). Each session data group may correspond to a single browsing session by a single user and may include a string of websites visited by that user during the browsing session. For example, session data group 112 includes data from Browsing Session 1 by User A. As shown in FIG. 3, User A visited Site 1 for a noted amount of time, then traveled to Site 2, Site 3, and Site 4 in that order. Session data group 112 may include all websites visited by User A before closing his/her browser window, indicated by “END” in session data group 112. As another example, Session data group 114 includes data from Browsing Session 3 by User B. As shown in FIG. 3, User B visited Site 4, Site 1, and Site 5, followed by any number of other site visits before reaching the END of Browsing Session 1. Additional examples are shown in FIG. 3 as Browsing Sessions 116 and 118.

The web page browsing information shown in FIG. 4 is only representative. In addition, web page browsing information may include, as examples, the time it takes a web page to load, the type of operating system being used, the screen resolution being used, and/or any other data related to the system, environment, web page, and/or user.

FIG. 4 also depicts a technique for filtering a set of session data groups into a subset of session data groups. For example, using session data groups described above, one example may include filtering session data groups 112, 114, 116, and 118 into subset 120 of session data groups corresponding to sessions that include a visit to Site 4—namely, session data groups 112, 114, and 116. Another example may include filtering sessions 112, 114, 116, and 118 into subset 122 of session data groups corresponding to sessions that include segments that took place after 9 p.m. local time—namely, session data groups 116 and 118.

Returning to FIG. 3, at Step 103, a local importance value may be calculated for each web site appearing in a session for each session present in a subset of session data groups. Each local importance value for a particular web site or web page may correspond to a relative importance of that web page in a particular individual session (e.g., each web site or web page has a separate local importance value determined for each session in which that web site is found). Each local importance value may be calculated using an algorithm or formula incorporating one or more characteristics of an important and/or useful web site or web page. For example, the local importance value for a particular web page in a particular session may be determined based on indicia of the relevant user's interest in the web page (e.g., the number of times the web page appears in the session, the total time spent viewing the web page, and/or the sequential rank of the web page in the session (i.e., how early the web page was accessed within the session)). As another example, the local importance value may be determined based on the characteristics of the particular session (e.g., the total number of events in the session and/or the total amount of time in the session). As another example, the local importance value may be calculated using an algorithm that provides additional weight to recent activity (e.g., reflecting data that may relate to more current content and/or activity).

At Step 104, for each web site referenced in the relevant subset of data sessions, the local importance values calculated for that web site may be aggregated to determine a web site importance value for that particular web site. For example, the aggregate importance value for a web page may include a sum of all the local importance values calculated for that web page. In another example, an aggregate importance value may be calculated for a web site or web host and may depend on the local importance values for each web page within the web site or web host. As another example, aggregate importance value may be updated as additional web browsing history data is collected.

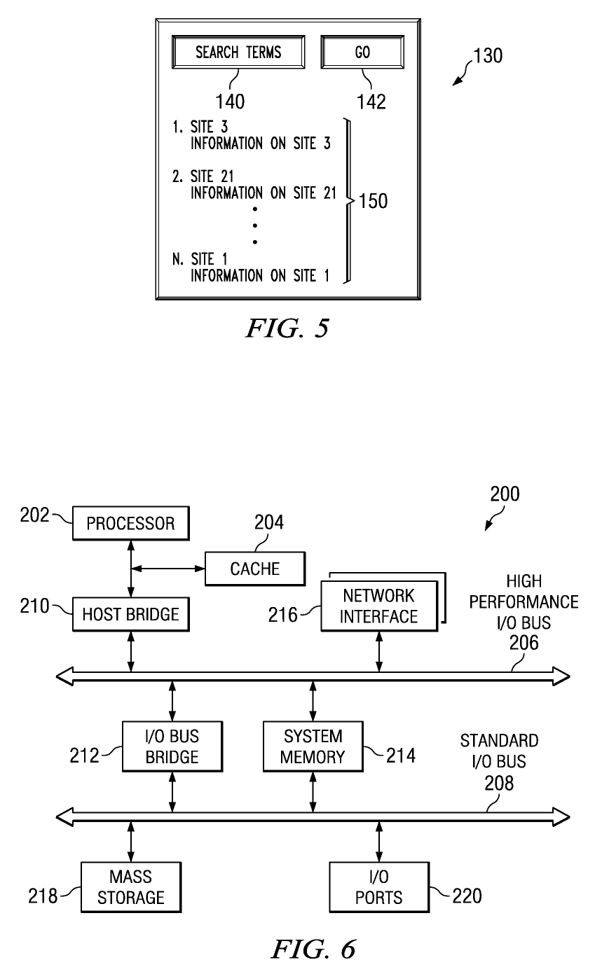

FIG. 5 illustrates a computer screen displaying the result from a search engine implementing methods of the current invention. In FIG. 4, display 130 may show search results 150 for search terms 140. Search results 150 may include a list of web sites corresponding to search terms 140, and prioritized by the importance values calculated using method 100 or another method incorporating the teachings of the present invention.

### D. Application

The importance values for web sites and web pages may be used to provide results for search engines or other web searches. The search results generated using the teachings of the present invention may be more useful or valuable to a user. As another example, the importance values may be used to generate a list of web pages with high importance values belonging to one or more web sites displayed in the search results. As another example, the importance values may be used to prioritize web crawling resources (e.g., web pages/web sites with higher importance values should be considered more frequently to provide the most current information).

The importance values generated by methods incorporating the teachings of the present invention may provide several benefits over other known methods. For example, data mined from actual use of a web page may be a more accurate representation of that web page's value or importance to a user than the underlying data structure of the web page. In addition, other known page ranking schemes may require constructing a map of the web pages and links and, therefore, consume more resources and time than the methods of the present invention.

Another benefit of the present invention may include an incremental approach. As new data becomes available, new local importance values can be calculated and added to the aggregate importance value. The prior known techniques may require repeated mapping and/or analysis each time new data is added. These prior known techniques demand substantial computing resources, often significantly higher than necessary to implement an incremental approach.

Another benefit of the present invention may include resistance to deliberate manipulation. A technique dependent on links between pages allows a web host to affect its rank by creating additional links solely for that purpose. In contrast to techniques that measure the total number of hits to a web site or web page, a web browsing history created by a robot or other spam program may be filtered out using any of several criteria (e.g., number of actions within a predetermined time slot).

### E. Example Computing System Architectures

While the foregoing systems can be implemented by a wide variety of physical systems and in a wide variety of network environments, the client and server host systems described below provide example computing architectures for didactic, rather than limiting, purposes.

FIG. 6 illustrates an example computing system architecture, which may be used to implement a physical server. In one embodiment, hardware system 200 comprises a processor 202, a cache memory 204, and one or more software applications and drivers directed to the functions described herein. Additionally, hardware system 200 includes a high performance input/output (I/O) bus 206 and a standard I/O bus 208. A host bridge 210 couples processor 202 to high performance I/O bus 206, whereas I/O bus bridge 212 couples the two buses 206 and 208 to each other. A system memory 214 and a network/communication interface 216 couple to bus 206. Hardware system 200 may further include video memory (not shown) and a display device coupled to the video memory. Mass storage 218, and I/O ports 220 couple to bus 208. Hardware system 200 may optionally include a keyboard and pointing device, and a display device (not shown) coupled to bus 208. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 200 are described in greater detail below. In particular, network interface 216 provides communication between hardware system 200 and any of a wide range of networks, such as an Ethernet (e.g., IEEE 802.3) network, etc. Mass storage 218 provides permanent storage for the data and programming instructions to perform the above described functions implemented in the location server 22, whereas system memory 214 (e.g., DRAM) provides temporary storage for the data and programming instructions when executed by processor 202. I/O ports 220 are one or more serial and/or parallel communication ports that provide communication between additional peripheral devices, which may be coupled to hardware system 200.

Hardware system 200 may include a variety of system architectures; and various components of hardware system 200 may be rearranged. For example, cache 204 may be on-chip with processor 202. Alternatively, cache 204 and processor 202 may be packed together as a “processor module,” with processor 202 being referred to as the “processor core.” Furthermore, certain embodiments of the present invention may not require nor include all of the above components. For example, the peripheral devices shown coupled to standard I/O bus 208 may couple to high performance I/O bus 206. In addition, in some embodiments only a single bus may exist, with the components of hardware system 200 being coupled to the single bus. Furthermore, hardware system 200 may include additional components, such as additional processors, storage devices, or memories.

As discussed below, in one implementation, the operations of one or more of the physical servers described herein are implemented as a series of software routines run by hardware system 200. These software routines comprise a plurality or series of instructions to be executed by a processor in a hardware system, such as processor 202. Initially, the series of instructions may be stored on a storage device, such as mass storage 218. However, the series of instructions can be stored on any suitable storage medium, such as a diskette, CD-ROM, ROM, EEPROM, etc. Furthermore, the series of instructions need not be stored locally, and could be received from a remote storage device, such as a server on a network, via network/communication interface 216. The instructions are copied from the storage device, such as mass storage 218, into memory 214 and then accessed and executed by processor 202.

An operating system manages and controls the operation of hardware system 200, including the input and output of data to and from software applications (not shown). The operating system provides an interface between the software applications being executed on the system and the hardware components of the system. According to one embodiment of the present invention, the operating system is the Windows® 95/98/NT/XP operating system, available from Microsoft Corporation of Redmond, Wash. However, the present invention may be used with other suitable operating systems, such as the Apple Macintosh Operating System, available from Apple Computer Inc. of Cupertino, Calif., UNIX operating systems, LINUX operating systems, and the like. Of course, other implementations are possible. For example, the server functionalities described herein may be implemented by a plurality of server blades communicating over a backplane.

Furthermore, the above-described elements and operations can be comprised of instructions that are stored on storage media. The instructions can be retrieved and executed by a processing system. Some examples of instructions are software, program code, and firmware. Some examples of storage media are memory devices, tape, disks, integrated circuits, and servers. The instructions are operational when executed by the processing system to direct the processing system to operate in accord with the invention. The term “processing system” refers to a single processing device or a group of inter-operational processing devices. Some examples of processing devices are integrated circuits and logic circuitry. Those skilled in the art are familiar with instructions, computers, and storage media.

The present invention has been explained with reference to specific embodiments. For example, while embodiments of the present invention have been described as operating in connection with web search engines, the present invention can be used in connection with any suitable application. Other embodiments will be evident to those of ordinary skill in the art. It is therefore not intended that the present invention be limited, except as indicated by the appended claims.

What is claimed is:

1. A method for estimating site importance, comprising
segmenting web site browsing history information regarding a plurality of browsing sessions into a set of session data groups, each session data group including browsing history data regarding one or more web sites corresponding to one of the browsing sessions; and
for each web site in the set of web sites:
calculating one or more local importance values for that web site, each local importance value for that web site indicating a relative importance of that web site in one session of the set of browsing sessions; and
aggregating the one or more local importance values calculated for that web site to determine a site importance for that website.

2. A method according to claim 1 wherein segmenting web site browsing history information into a set of session data groups includes assuming a session timeout if the there was no activity over a predetermined time threshold.

3. A method according to claim 1 wherein segmenting web site browsing history information into a set of session data groups includes following http referrer information to identify when a user browsed from site to site.

4. A method according to claim 1 wherein segmenting web site browsing history information into a set of session data groups wherein the web site browsing history includes one user action selected from the group consisting of: opening a browser window, closing a browser window, opening a browser tab, closing a browser tab, following a stored web page bookmark, or refreshing the contents of a web page.

5. A method according to claim 1 further comprising filtering the set of session data groups into a subset of session data groups before calculating a local importance value, the filtering based on at least one filtering criterion, the subset of session data groups including data regarding a set of web sites corresponding to a subset of the browsing sessions.

6. A method according to claim 1 wherein the at least one filtering criterion is selected from the group consisting of: demographic of the user, local time of the session, date range of the session, and whether the session contains a particular browsing activity.

7. A method according to claim 1 further comprising gathering web site browsing history information for a plurality of users using a client side browser tool bar.

8. A method according to claim 1 further comprising gathering web site browsing history information for a plurality of users using a server side process.

9. A method according to claim 1 wherein a particular local importance values for a particular web site in a particular browsing session is calculated based at least on one or more factors selected from the group consisting of: the number of times the particular web site appears in the session, the sequential rank of the particular web site within the particular browsing session, the total time spent viewing the particular web site, the total number of events in the particular browsing session, the web page load time, and the total amount of time spent in the particular browsing session.

10. A method according to claim 1 wherein a session data group includes a list of all web sites accessed by a user and the time at which each web site was accessed.

11. An apparatus comprising:
one or more processors;
one or more network interfaces;
a memory; and
computer-executable instructions carried on a computer readable medium, the one or more processors, the instructions, when read and executed for causing the one or more processors to:
segment web site browsing history information regarding a plurality of browsing sessions into a set of session data groups, each session data group including browsing history data regarding one or more web sites corresponding to one of the browsing sessions; and
for each web site in the set of web sites:
calculate one or more local importance values for that web site, each local importance value for that web site indicating a relative importance of that web site in one browsing session; and
aggregate the one or more local importance values calculated for that web site to determine a site importance for that website.

12. An apparatus according to claim 11 further comprising filtering the set of session data groups into a subset of session data groups before calculating a local importance value, the filtering based on at least one filtering criterion, the subset of session data groups including data regarding a set of web sites corresponding to a subset of the browsing sessions.

13. An apparatus according to claim 11 wherein segmenting web site browsing history information into a set of session data groups wherein the web site browsing history includes one user action selected from the group consisting of: opening a browser window, closing a browser window, opening a browser tab, closing a browser tab, following a stored web page bookmark, or refreshing the contents of a web page.

14. An apparatus according to claim 11 wherein the at least one filtering criterion is selected from the group consisting of: demographic of the user, local time of the session, date range of the session, and whether the session contains a particular browsing activity.

15. An apparatus according to claim 11 further comprising computer-executable instructions for gathering web site browsing history information for a plurality of users using a client side browser tool bar.

16. An apparatus according to claim 11 further comprising computer-executable instructions for gathering web site browsing history information for a plurality of users using a server side process.

17. An apparatus according to claim 11 wherein the one or more local importance values for each web site is calculated for a session appearing in the subset of sessions, the calculation including a function of a component selected from the group consisting of: the number of times the web site appears in the session, the sequential order of the web site within the session, the total time spent viewing the site, the total number of events in the session, and the total amount of time spent in the session.

18. A method for providing search results comprising:
providing a web-based interface to a user;
accepting user input, the user input including one or more search terms;
identifying a plurality of web sites containing information relevant to the one or more search terms; and
displaying the plurality of web sites to the user in order of a ranking, wherein the ranking is based at least on a calculated respective site importance;
wherein the site importance of each web site is calculated by a method comprising:
segmenting web site browsing history information regarding a plurality of browsing sessions into a set of session data groups, each session data group including browsing history data regarding one or more web sites corresponding to one of the browsing sessions; and
for each web site in the set of web sites:
calculating one or more local importance values for that web site, each local importance value for that web site indicating a relative importance of that web site in one session; and
aggregating the one or more local importance values calculated for that web site to determine a site importance for that website.

19. A method according to claim 18 further comprising gathering web site browsing history information for a plurality of users using a client side browser tool bar.

20. A method according to claim 18 further comprising displaying a list of shortcut links associated with the plurality of web sites, the shortcut links having the highest importance rating of web pages associated with each of the plurality of web sites.

21. A method according to claim 18 further comprising filtering the set of session data groups into a subset of session data groups based on at least one filtering criterion, the subset of session data groups including data regarding a set of web sites corresponding to a subset of the browsing sessions.
